(19) United States
(12) Patent Application Publication
(10) Pub. No.: US 2005/0282133 A1
(43) Pub. Date: Dec. 22, 2005

(54) System and method for facilitating computer-based testing using traceable test items

(76) Inventor: Christopher Crowhurst, Whitehall, MD (US)

Correspondence Address: ARENT FOX PLLC, 1050 CONNECTICUT AVENUE, N.W., SUITE 400, WASHINGTON, DC, 20036, US

(21) Appl. No.: 10/870,428

(22) Filed: Jun. 18, 2004

(51) Int. Cl. G09B 7/00

(52) U.S. Cl. 434/323

(57) ABSTRACT

A system for facilitating computer-based testing according to an embodiment of the present invention includes a server facility and a test taking facility. Specifically, the server facility is configured to store one or more test items, associate a unique identifier with the one or more test items, and alter the one or more test items in accordance with the unique identifier to generate one or more traceable test item. Moreover, the test taking facility is configured to receive the one or more traceable test items from the server facility, and present the one or more traceable test items to a test taker during a computer-based testing session.

### BACKGROUND OF THE INVENTION

1. Field of the Invention

The present invention relates generally to systems and methods for facilitating computer-based testing. In particular, the present invention is directed towards systems and methods in which a test item is altered in accordance with a unique identifier in order to generate a traceable test item, and the traceable test item is included in a Computer-Based Test which is presented to a test taker.

2. Description of the Related Art

A Computer-Based Test may be defined as a test or an assessment that includes one or more test items, e.g., one or more test questions, and is administered via a processing arrangement, such as a computer, linked to an electronic data network, e.g., the Internet, the World Wide Web, an extranet, or an intranet. In general, a Computer-Based Test may be an assessment test designed to test a test taker's proficiency in a particular field, a certification test designed to allow a test taker to become certified in a particular field when the test taker correctly answers a predetermined number of test items, an academic test, e.g., a Law School Admission Test (“LSAT”) or a Standardized Academic Test (“SAT”), an academic practice test used to prepare for the academic test, or the like.

Specifically, a test item provider formulates test items to be incorporated into Computer-Based Tests, and the test item provider transmits the test items and test specifications, e.g., test outlines or test blueprints, to a server facility. The server facility stores the test items in a test item bank, and also generates Computer-Based Tests in accordance with the test item provider's test specifications, such that each Computer-Based Test includes some or all of the test items stored in the test item bank. Thus, at least some of the test items included in a first of the Computer-Based Tests generally are identical to at least some of the test items included in a second of the Computer-Based Tests. After the server facility generates the Computer-Based Tests, a registered test taker, e.g., a test taker that has paid a test taking fee to the test item provider and/or the server facility, may take one or more of the Computer-Based Tests by accessing a web site associated with the server facility. Alternatively, the registered test taker can take one or more of the Computer-Based Tests at a test taking facility, e.g., a facility operated by or in association with the server facility. Specifically, the server facility may transmit the Computer-Based Tests to the test taking facility, and several test takers may take one or more of the Computer-Based Tests at the test taking facility on a predetermined date and at a predetermined time.

The development of test items by the test item provider is an expensive process. Consequently, once a sufficient number of test items are included in the test item bank, it is desirable to continuously generate new Computer-Based Tests over a predetermined amount of time, e.g., between about six months and about five years, without having to update or substantially update the test item bank. Nevertheless, each time a Computer-Based Test is administered to a test taker, the test taker has an opportunity to copy some or all of the test items which are included in their computer-based test, and to distribute these copied test items to others. Once the test taker distributes the copied test items to others, the distributed test items no longer are suitable for inclusion in future Computer-Based Tests, and the test item provider needs to formulate new test items in order to replace the distributed test items. Moreover, because multiple test takers likely took a Computer-Based Test that included the distributed test items, it is difficult if not nearly impossible to identify the test taker who distributed the test items.

### SUMMARY OF THE INVENTION

Accordingly, a need has arisen for systems and methods for facilitating computer-based testing which overcome these and other shortcomings of the related art. A technical advantage of the present invention is that a test item may be altered in accordance with a unique identifier to generate a traceable test item, and the traceable test item may be included in a Computer-Based Test. Consequently, if the traceable test item is distributed, the unique identifier can be used to determine the identify of the test taker who had access to the traceable test item during a computer-based testing session, e.g., because none of the test items included in other computer-based tests are identical to the traceable test item.

According to an exemplary embodiment of the present invention, a system for facilitating computer-based testing comprises a server facility and a test taking facility. The server facility is configured to store at least one test item, associate a unique identifier with the at least one test item, and alter the at least one test item in accordance with the unique identifier to generate at least one traceable test item. Moreover, the test taking facility is configured to receive the at least one traceable test item, and present the at least one traceable test item during a computer-based testing session.

According to another exemplary embodiment of the present invention, a system for facilitating computer-based testing comprises a server facility. Specifically, the server facility is configured to store at least one test item, and generate at least one traceable test item by altering the at least one test item in accordance with a unique identifier. The server facility also is configured to transmit the at least one traceable test item to a test taking facility that is configured to present the at least one test item during a computer-based testing session.

According to yet another exemplary embodiment of the present invention, a system for facilitating computer-based testing comprises a server facility. The server facility is configured to store at least one test item, and associate a unique identifier with the at least one test item. The server facility also is configured to alter the at least one test item in accordance with the unique identifier to generate at least one traceable test item, and present the at least one traceable test item during a computer-based testing session.

According to still yet another exemplary embodiment of the present invention, a system for facilitating computer-based testing comprises a server facility. The server facility is configured to store at least one test item, and generate at least one traceable test item by altering the at least one test item in accordance with a unique identifier. The server facility also is configured to present the at least one test item during a computer-based testing session.

According to a further exemplary embodiment of the present invention, a system for facilitating computer-based testing comprises means for storing at least one test item, and means for associating a unique identifier with the at least one test item. The system also comprises means for altering the at least one test item in accordance with the unique identifier to generate at least one traceable test item, and means for presenting the at least one traceable test item during a computer-based testing session.

According to another exemplary embodiment of the present invention, a system for facilitating computer-based testing comprises means for storing at least one test item, and means for generating at least one traceable test item by altering the at least one test item in accordance with a unique identifier. The system also comprises means for presenting the at least one test item during a computer-based testing session.

According to yet another exemplary embodiment of the present invention, a method for facilitating computer-based testing comprises the steps of storing at least one test item, and associating a unique identifier with the at least one test item. The method also comprises the steps of altering the at least one test item in accordance with the unique identifier to generate at least one traceable test item, and presenting the at least one traceable test item during a computer-based testing session.

According to still yet another exemplary embodiment of the present invention, a method for facilitating computer-based testing comprises the steps of storing at least one test item, and generating at least one traceable test item by altering the at least one test item in accordance with a unique identifier. The method also comprises the step of presenting the at least one test item during a computer-based testing session.

Other objects, features, and advantages will be apparent to persons of ordinary skill in the art from the following detailed description of the invention and the accompanying drawings.

### BRIEF DESCRIPTION OF THE DRAWINGS

Below, a detailed description of the present invention is provided with reference to the attached drawing figures which are briefly described as follows:

FIG. 1A is a schematic diagram of a system for facilitating computer-based testing according to an exemplary embodiment of the present invention.

FIG. 1B is a schematic diagram of a system for facilitating computer-based testing according to another exemplary embodiment of the present invention.

FIG. 1C is a schematic diagram of a system for facilitating computer-based testing according to yet another exemplary embodiment of the present invention.

FIG. 1D is a schematic diagram of a system for facilitating computer-based testing according to still yet another exemplary embodiment of the present invention.

FIG. 2A is a schematic diagram of a system for facilitating computer-based testing according to an exemplary embodiment of the present invention.

FIG. 2B is a schematic diagram of a system for facilitating computer-based testing according to another exemplary embodiment of the present invention.

FIG. 2C is a schematic diagram of a system for facilitating computer-based testing according to yet another exemplary embodiment of the present invention.

FIG. 2D is a schematic diagram of a system for facilitating computer-based testing according to still yet another exemplary embodiment of the present invention.

FIG. 3 is a block diagram of a server facility which may be used by any of the systems for facilitating computer-based testing depicted in FIGS. 1A-2D, according an exemplary embodiment of the present invention.

FIGS. 4A-4C are block diagrams of exemplary Computer-Based Tests that include one or more traceable test items, according to exemplary embodiments of the present invention.

FIG. 5 is a flow chart that illustrates a method of facilitating computer-based testing according to an exemplary embodiment of the present invention.

FIG. 6 is a flow chart that illustrates a method of facilitating computer-based testing according to another exemplary embodiment of the present invention.

### DETAILED DESCRIPTION OF PREFERRED EMBODIMENTS

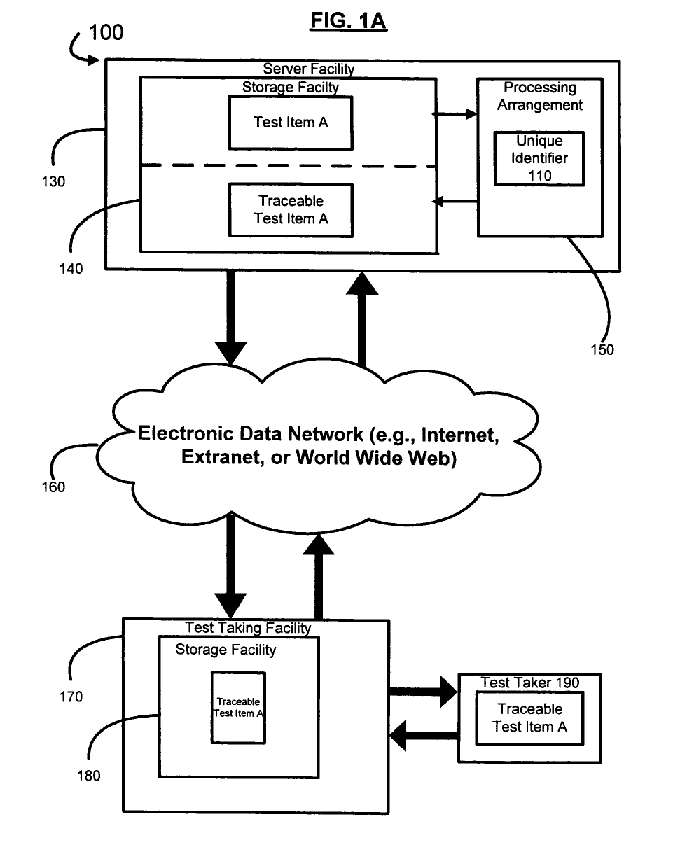

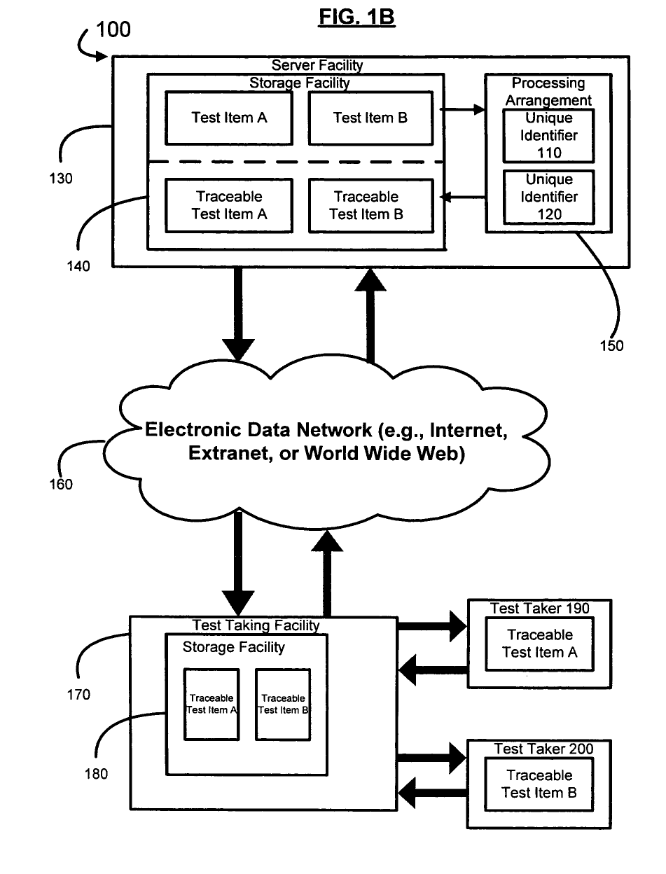

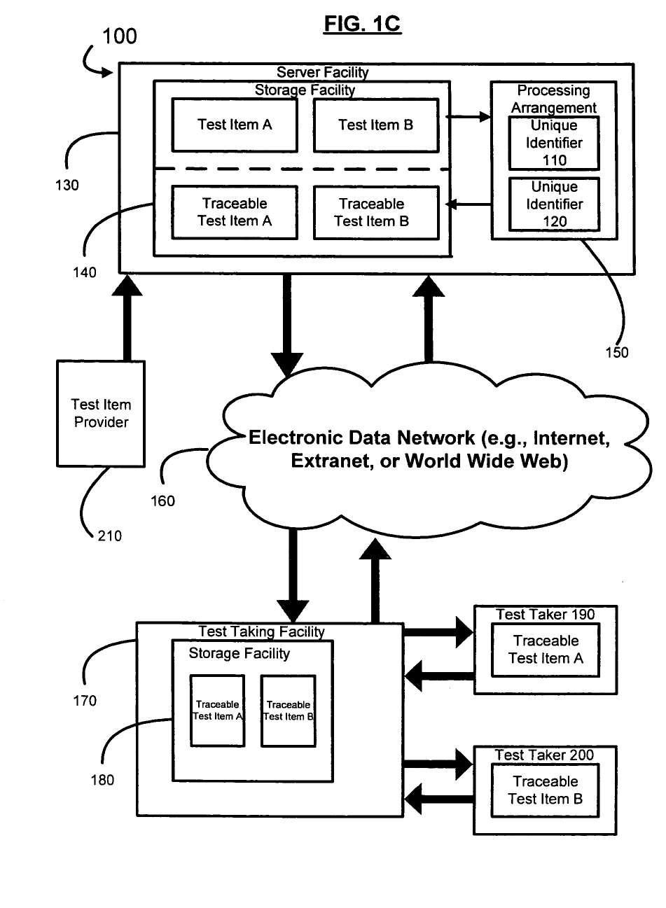

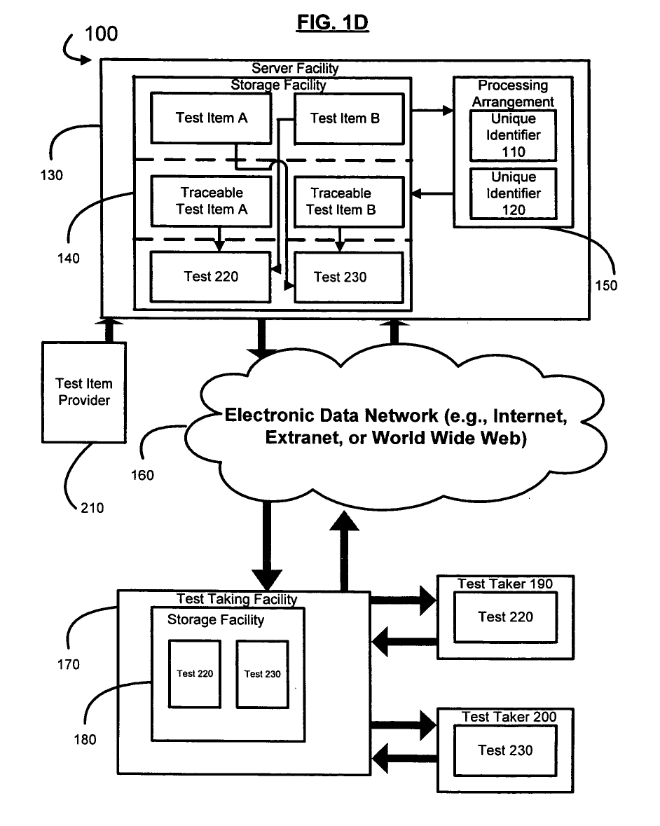

Preferred embodiments of the present invention and their features and advantages may be understood by referring to FIGS. 1A-6, like numerals being used for like corresponding parts in the various drawings.

The terms that are capitalized below bear the following meanings.

The WWW is the World Wide Web and its associated protocols and related technologies which may be accessed via the Internet.

An Electronic Data Network is any type of network environment from which at least one coupled processing arrangement, e.g., computer, is configured to receive content and to process the same. Exemplary electronic data networks include the Internet, the WWW, an extranet, and an intranet.

A Computer-Based Test is any test or assessment that includes one or more test items, e.g., one or more test questions, and is administered via a processing arrangement, such as a computer, linked to an Electronic Data Network.

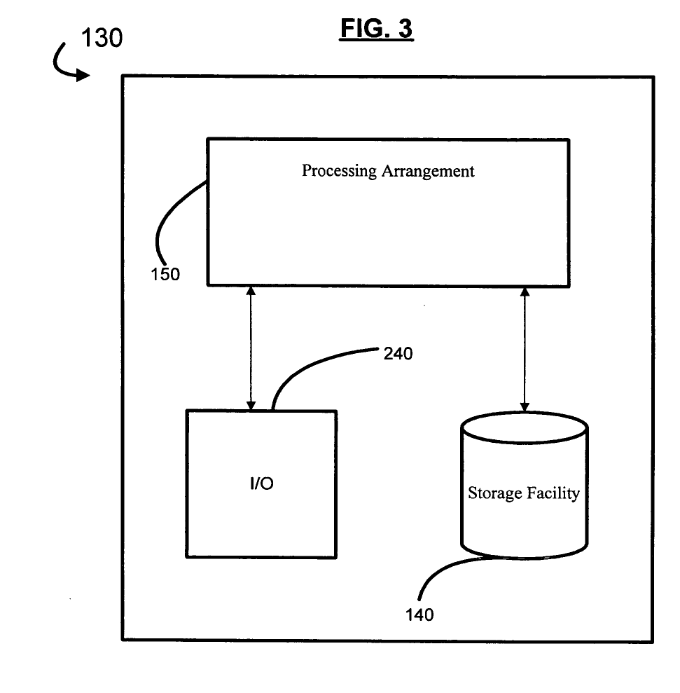

FIG. 1A depicts a system 100 for facilitating computer-based testing according to an embodiment of the present invention. System 100 may comprise a server facility 130 and a testing facility 170 that is coupled to server facility 130 via an Electronic Data Network 160. As shown in FIGS. 1A and 3, server facility 130 may comprise a processing arrangement 150, a storage facility 140, and an I/O system 240 which supports network communications. Specifically, server facility 130 may receive a test item A, e.g., a test question, via I/O system 240, and may store test item A in storage facility 140. For example, as shown in FIG. 1C, a test item provider 210 may transmit test item A to storage facility 140 via I/O system 240. Test item A then may be transmitted from storage facility 140 to processing arrangement 150. In particular, processing arrangement 150 may associate a first unique identifier 110 with test item A, and also may alter test item A in accordance with first unique identifier 110 to generate a traceable test item A. Processing arrangement 150 then may transmit traceable test item A to storage facility 140 for storage therein. However, it readily will be understood by those of ordinary skill in the art that a plurality of traceable test items A may be generated from a single test item A using a unique identifier for each of the traceable test items A.

For example, test item A may be question to be incorporated into one or more Computer-Based Tests, and processing arrangement 150 may associate first unique identifier 110 with test item A based on a content of test item A. Specifically, in one exemplary embodiment, test item A may comprise a plurality of words, and processing arrangement 150 may alter test item A in accordance with first unique identifier 110 by replacing at least one particular word of the plurality of words with at least one replacement word that comprises first unique identifier 110. The at least one replacement word may comprise a synonym of the at least one particular word, an abbreviation of the at least one particular word, or the like. For example, if test item A includes the word: “cat,” processing arrangement 150 may replace the word: “cat” with the word: “feline” to generate traceable test item A. Traceable test item A then may be stored in storage facility 140. A similar approach may be employed when test item A includes the name of a person, the name of a city, the name of a company, or any other word which is interchangeable within the context of the test item. For example, if test item A includes the word: “Philadelphia,” processing arrangement 150 may replace the word: “Philadelphia” with the word: “Miami” or the word: “New York City” to generate traceable test item A. Moreover, as described-above, processing arrangement 150 may generate a plurality of traceable test items A from test item A. For example, processing arrangement 150 may generate a first traceable test item A by replacing the word: “Philadelphia” with the word: “Miami,” and also may generate a second traceable test item A by replacing the word: “Philadelphia” with the word: “New York City.” Thus, it is possible for processing arrangement to generate a plurality of traceable test items from a single test item. In a modification of this embodiment, processing arrangement 150 may alter test item A in accordance with first unique identifier 110 by replacing several particular words of the plurality of words, and the combination of the several replaced particular words may represent first unique identifier 110. For example, replacing several of the particular words (versus replacing a single particular word) increases the number of unique identifiers that are available for a particular test item.

In another exemplary embodiment, test item A may comprise a plurality of numbers, and processing arrangement 150 may alter test item A in accordance with first unique identifier 110 by replacing at least one particular number of the plurality of numbers with at least one replacement number that comprises first unique identifier 110. For example, if test item A includes the equation: “(4x+6)(2x−3)=8,” processing arrangement 140 may replace the equation: “(4x+6)(2x−3)=8” with the equation “(4x+8)(2x−3)=8” to generate traceable test item A. Processing arrangement 150 also may use a more robust numeric replacement approach by employing a mapping of numbers to embed first unique identifier 110 within test item A to generate traceable test item A. In yet another exemplary embodiment, test item A may comprise at least one image, and processing arrangement 150 may alter test item A in accordance with first unique identifier 110 by replacing the at least one image with at least one replacement image that comprises first unique identifier 110. For example, first unique identifier 110 may comprise a modified portion of the at least one image of test item A. In still yet another embodiment, test item A may comprise a plurality of punctuation marks, e.g., commas, semicolons, quotation marks, brackets, periods, question marks, exclamation points, or the like, and processing arrangement 150 may alter test item A in accordance with first unique identifier 110 by replacing at least one punctuation mark of the plurality of punctuation marks with at least one replacement punctuation mark that comprises first unique identifier 110.

Referring to FIG. 1B, in addition to receiving test item A, server facility 130 also may receive a test item B, and may store test item B in storage facility 140. Test item B then may be transmitted from storage facility 140 to processing arrangement 150. In particular, processing arrangement 150 may associate a second unique identifier 120 with test item B, and also may alter test item B in accordance with second unique identifier 120 to generate a traceable test item B. The method for generating traceable test item B may be substantially similar to the above-described method for generating traceable test item A, and processing arrangement 150 may generate a plurality of traceable test items B. Processing arrangement 150 then may transmit traceable test item B to storage facility 140 for storage therein. Moreover, it readily will understood by those of ordinary skill in the art that server facility 130 may receive any number of test items, e.g., between one test item and about five thousand test items, and processing arrangement 150 may generate any number of traceable test items from each test item.

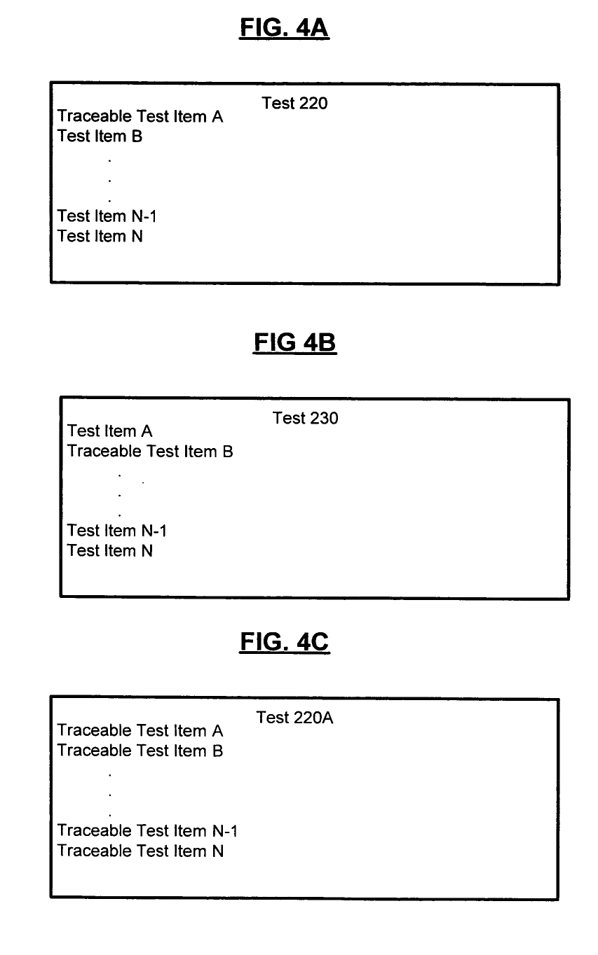

Referring to FIGS. 1A and 1B, after traceable test item A and/or traceable test item B is stored in storage facility 140, traceable test item A and/or traceable test item B may be transmitted to test taking facility 170 and stored in a storage facility 180 of test taking facility 170. Alternatively, as shown in FIG. 1D, processing arrangement 150 first may generate one or more Computer-Based Tests that include at least one of the traceable test items, and server facility 130 may transmit such Computer-Based Tests to test taking facility 170. In any of these embodiments, test taking facility 170 may be a facility which is operated by or is associated with server facility 130. Specifically, a first test taker 190 may register, e.g., pay a fee to server facility 130 and/or test item provider 210, to take one or more Computer-Based Tests at test taking facility 170 on a predetermined date and at a predetermined time, and a second test taker 200 also may register to take one or more Computer-Based Tests at test taking facility 170 on the predetermined date and at the predetermined time. When first test taker 190 and/or second test taker 200 arrive at test taking facility 170, they may be given access to a computer. Test taking facility 170 then may transmit the one or more of the Computer-Based Tests to each of the computers, e.g., via an Electronic Data Network or by downloading the one or more Computer-Based Tests to the computer, such that test taking facility 170 presents, e.g., manifests, the Computer-Based Test to first test taker 190 and/or second test taker 200. For example, referring to FIGS. 4A and 4B, a first Computer-Based Test 220 which includes traceable item A may be transmitted to first test taker 190, and a second Computer-Based Test 230 which includes traceable item B may be transmitted to second test taker 200. In another embodiment, as shown in FIG. 4C, any number of the test items included in the Computer-Based Test may be traceable test items, e.g., all of the test items included in the Computer-Based Test may be traceable test items, or some of the test items may be traceable test items. After first test taker 190 and/or second test taker 200 finish their Computer-Based Test, test taking facility 170 may transmit the completed Computer-Based Test to server facility 130, and server facility 130 may store the completed Computer-Based Test in storage facility 140. Moreover, server facility 130 may provide the results of the Computer-Based Test to the test taker.

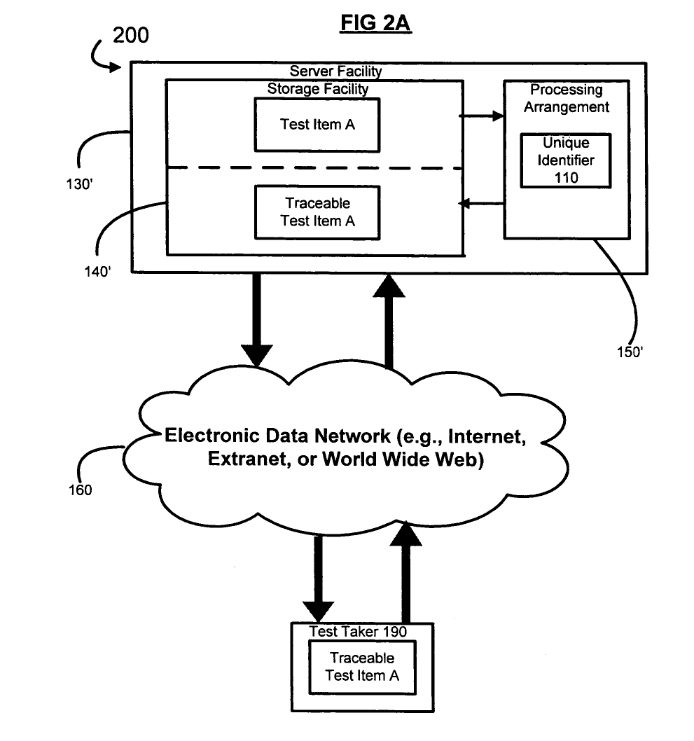

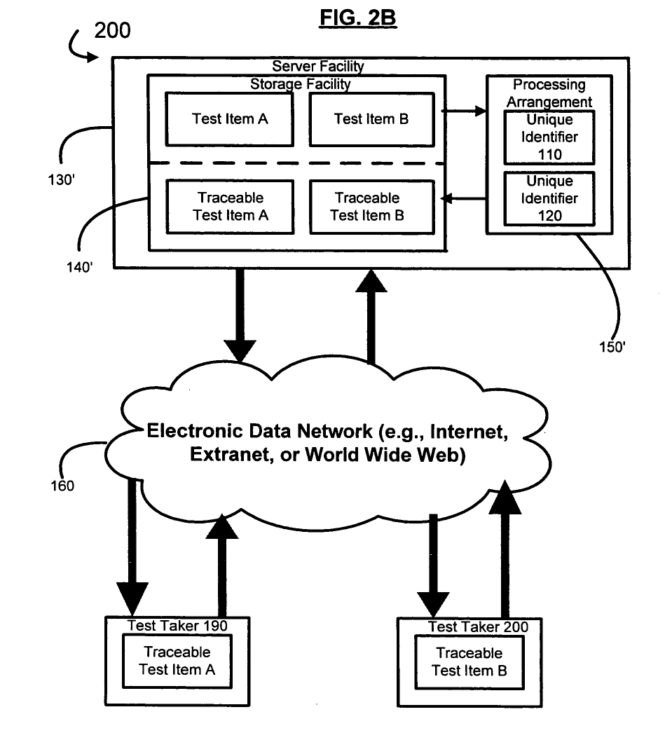

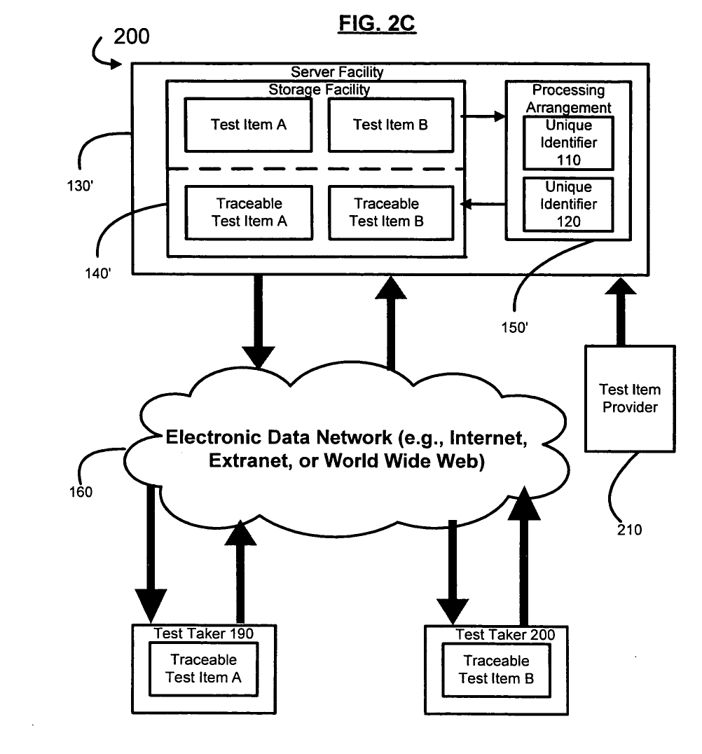

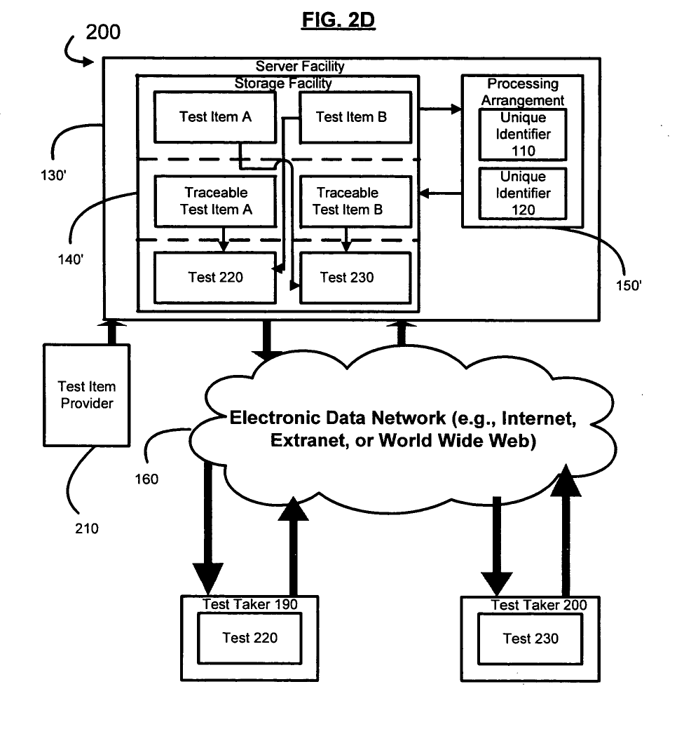

FIG. 2A depicts a system 200 for facilitating computer-based testing according to another embodiment of the present invention. System 200 may comprise a server facility 130′ coupled to each of the test takers, e.g., first test taker 190 and/or second test taker 200, via Electronic Data Network 160. As shown in FIGS. 2A, server facility 130′ may comprise a processing arrangement 150′, a storage facility 140′, and I/O system 240 which supports network communications. Specifically, server facility 130′ may receive a test item A, e.g., a test question, via I/O system 240, and may store test item A in storage facility 140′. For example, as shown in FIG. 2C, test item provider 210 may transmit test item A to storage facility 140′ via I/O system 240. Test item A then may be transmitted from storage facility 140′ to processing arrangement 150′. In particular, processing arrangement 150′ may associate first unique identifier 110 with test item A, and also may alter test item A in accordance with first unique identifier 110 to generate a traceable test item A. Processing arrangement 150′ then may transmit traceable test item A to storage facility 140′ for storage therein. However, it readily will be understood by those of ordinary skill in the art that a plurality of traceable test items A may be generated from a single test item A using a unique identifier for each of the traceable test items A. Moreover, the method for generating traceable item A may be substantially the same as in the above-described exemplary embodiments of the present invention.

Referring to FIG. 2B, in addition to receiving test item A, server facility 130′ also may receive a test item B, and may store test item B in storage facility 140′. Test item B then may be transmitted from storage facility 140′ to processing arrangement 150′. In particular, processing arrangement 150′ may associate second unique identifier 120 with test item B, and also may alter test item B in accordance with second unique identifier 120 to generate a traceable test item B. The method for generating traceable test item B may be substantially the same as in the above-described embodiments of the present invention, and processing arrangement 150′ may generate a plurality of traceable test items B. Processing arrangement 150′ then may transmit traceable test item B to storage facility 140′ for storage therein. Moreover, it readily will understood by those of ordinary skill in the art that server facility 130′ may receive any number of test items, e.g., between one test item and about five thousand test items, and processing arrangement 150 may generate any number of traceable test items from each test item.

Referring to FIGS. 2A and 2B, after traceable test item A and/or traceable test item B is stored in storage facility 140′, a registered test taker, e.g., first test taker 190 and/or second test taker 200, may access traceable testy item A and/or traceable test item B by accessing a web site associated with server facility 130 via Electronic Data Network 160. Alternatively, as shown in FIG. 2D, processing arrangement 150′ first may generate one or more Computer-Based Tests that include at least one of the traceable test items, and the registered test taker may access the one or more Computer-Based Tests by accessing the web site associated with server facility 130 via Electronic Data Network 160. As such, in either of these embodiments of the present invention, server facility 130′ presents, e.g., manifests, the Computer-Based Test to first test taker 190 and/or second test taker 200. For example, referring to FIGS. 4A and 4B, first test taker 190 may access first Computer-Based Test 220 which includes traceable item A, and second test taker 200 may access second Computer-Based Test 230 which includes traceable item B. In another embodiment, as shown in FIG. 4C, any number of the test items included in the Computer-Based Test may be traceable test items, e.g., all of the test items included in the Computer-Based Test may be traceable test items, or some of the test items may be traceable test items. After first test taker 190 and/or second test taker 200 finish their Computer-Based Test, server facility 130′ may store the completed Computer-Based Test in storage facility 140′. Moreover, server facility 130′ may provide the results of the Computer-Based Test to the test taker.

In any of the above-described embodiments of the present invention, because an unique identifier may be associated with some or all of the test items included in the Computer-Based Tests, when a test item which includes a unique identifier is distributed, the identity of the test taker who had access to the distributed test item during a computer-based testing session is determinable, e.g., because none of the test items included in other computer-based tests are identical to the traceable test item.

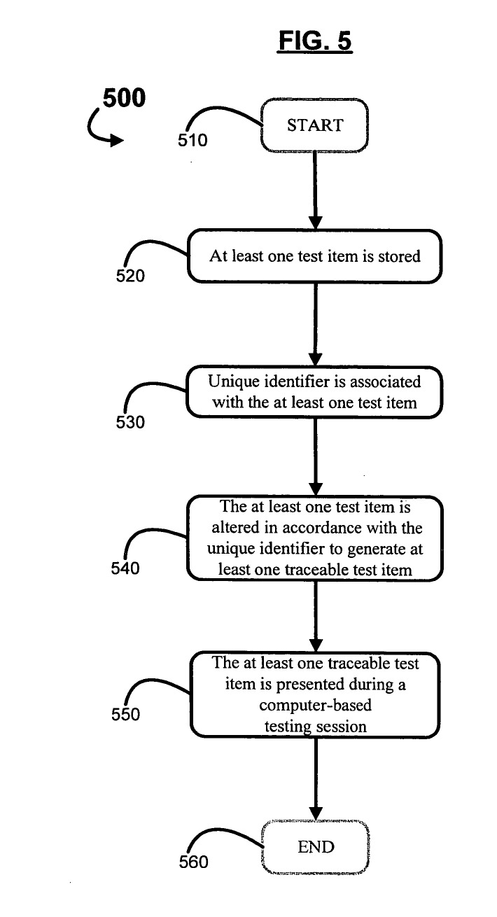

Referring now to FIG. 5, depicted therein is a general process flow chart that illustrates a method 500 of facilitating computer-based testing according to an exemplary embodiment of the present invention. Method 500 may be employed using any of the above-described embodiments of system 100 and/or system 200. Specifically, in step 510, method 500 starts, and in step 520, at least one test item, e.g., test item A and/or test item B, is stored, e.g., in storage facility 140 (140′). For example, the at least one test item may be transmitted from test item provider 210 to storage facility 140 (140′). In step 530, a unique identifier, e.g., first unique identifier 110 and/or second unique identifier 120, is associated with the at least one test item, e.g., based on a content of the at least one test item. The unique identifier may be any of the unique identifiers described above with respect to system 100 and/or system 200. In step 540, the at least one test item is altered in accordance with the unique identifier to generate at least one traceable test item, e.g., traceable test item A and/or traceable test item B. For example, the at least one test item may comprise a plurality of words or numbers, and processing arrangement 150 (150′) may alter the at least one test item in accordance with the unique identifier by replacing at least one particular word or number of the plurality of words or numbers with at least one replacement word or number that comprises the unique identifier. Alternatively, the at least one test item may comprise at least one image, and processing arrangement 150 (150′) may alter the at least one test item in accordance with the unique identifier by replacing the at least one image with at least one replacement image that comprises the unique identifier. Moreover, in step 550, the at least one traceable test item is presented during a computer-based testing session, e.g., presented by test taking facility 170 or server facility 130′. Finally, in step 560, method 500 ends.

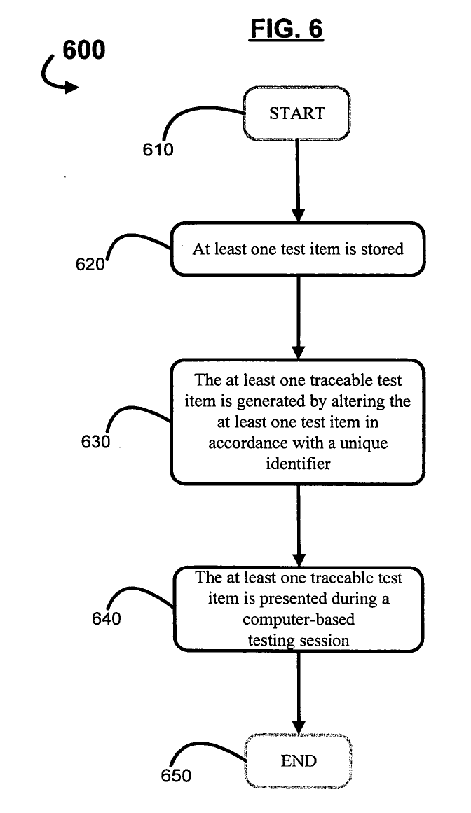

Referring now to FIG. 6, depicted therein is a general process flow chart that illustrates a method 600 of facilitating computer-based testing according to another exemplary embodiment of the present invention. Method 600 may be employed using any of the above-described embodiments of system 100 and/or system 200. Specifically, in step 610, method 600 starts, and in step 620, at least one test item, e.g., test item A and/or test item B, is stored, e.g., in storage facility 140 (140′). For example, the at least one test item may be transmitted from test item provider 210 to storage facility 140 (140′). In step 630, at least one traceable test item is generated by altering the at least one test item in accordance with a unique identifier, e.g., first unique identifier 110 and/or second unique identifier 120. For example, the at least one test item may comprise a plurality of words or numbers, and processing arrangement 150 (150′) may alter the at least one test item in accordance with the unique identifier by replacing at least one particular word or number of the plurality of words or numbers with at least one replacement word or number that comprises the unique identifier. Alternatively, the at least one test item may comprise at least one image, and processing arrangement 150 (150′) may alter the at least one test item in accordance with the unique identifier by replacing the at least one image with at least one replacement image that comprises the unique identifier. Moreover, in step 640, the at least one traceable test item is presented during a computer-based testing session, e.g., presented by test taking facility 170 or server facility 130′. Finally, in step 650, method 600 ends.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

1. A system for facilitating computer-based testing, comprising:
a server facility configured to:
store at least one test item;
associate a unique identifier with the at least one test item; and
alter the at least one test item in accordance with the unique identifier to generate at least one traceable test item; and
a test taking facility configured to:
receive the at least one traceable test item; and
present the at least one traceable test item during a computer-based testing session.

2. The system of claim 1, wherein the server facility is further configured to associate the unique identifier with the at least one test item based on a content of the at least one test item.

3. The system of claim 1, wherein the at least one test item comprises a plurality of words, and the server facility is further configured to alter the at least one test item in accordance with the unique identifier by replacing at least one particular word of the plurality of words with at least one replacement word comprising the unique identifier.

4. The system of claim 3, wherein the at least one replacement word comprises a synonym of the at least one particular word.

5. The system of claim 3, wherein the at least one replacement word comprises an abbreviation of the at least one particular word.

6. The system of claim 1, wherein the at least one test question comprises a plurality of numbers, and the server facility is further configured to alter the at least one test item in accordance with the unique identifier by replacing at least one particular number of the plurality of numbers with at least one replacement number comprising the unique identifier.

7. The system of claim 1, wherein the at least one test item comprises at least one image, and the server facility is further configured to alter the at least one test item in accordance with the unique identifier by replacing the at least one image with at least one traceable image comprising the unique identifier.

8. The system of claim 1, wherein the test-taking facility is coupled to the server facility via an electric data network.

9. The system of claim 1, wherein the at least test item comprises a plurality of punctuation marks, and the server facility is further configured to alter the at least one test item in accordance with the unique identifier by replacing at least one particular punctuation mark of the plurality of punctuation marks with at least one replacement punctuation mark comprising the unique identifier.

10. The system of claim 1, wherein the server facility is further configured to associate the unique identifier with the at least one test item by assigning the unique identifier to the at least one test item.

11. The system of claim 1, wherein the test taking facility is further configured to present the at least one test item during the Computer-Based Tests by manifesting the at least one test item during the computer-based test.

12. The system of claim 1, wherein the unique identifier comprises a unique test item delivery code.

13. A system for facilitating computer-based testing, comprising a server facility configured to:
store at least one test item;
generate at least one traceable test item by altering the at least one test item in accordance with a unique identifier; and
transmit the at least one traceable test item to a test taking facility configured to present the at least one test item during a computer-based testing session.

14. The system of claim 13, wherein the at least one test item comprises a plurality of words, and the server facility is further configured to generate the at least one traceable test item by replacing at least one particular word of the plurality of words with at least one replacement word comprising the unique identifier.

15. The system of claim 14, wherein the at least one replacement word comprises a synonym of the at least one particular word.

16. The system of claim 14, wherein the at least one replacement word comprises an abbreviation of the at least one particular word.

17. The system of claim 13, wherein the at least one test question comprises a plurality of numbers, and the server facility is further configured to generate the at least one traceable test item by replacing at least one particular number of the plurality of numbers with at least one replacement number comprising the unique identifier.

18. The system of claim 13, wherein the at least one test item comprises at least one image, and the server facility is further configured to generate the at least one traceable test item by replacing the at least one image with at least one traceable image comprising the unique identifier.

19. The system of claim 13, wherein the at least test item comprises a plurality of punctuation marks, and the server facility is further configured to alter the at least one test item in accordance with the unique identifier by replacing at least one particular punctuation mark of the plurality of punctuation marks with at least one replacement punctuation mark comprising the unique identifier.

20. The system of claim 13, wherein the test taking facility is further configured to present the at least one test item during the Computer-Based Tests by manifesting the at least one test item during the computer-based test.

21. The system of claim 13, wherein the unique identifier comprises a unique test item delivery code.

22. A system for facilitating computer-based testing, comprising:
a server facility configured to:
store at least one test item;
associate a unique identifier with the at least one test item;
alter the at least one test item in accordance with the unique identifier to generate at least one traceable test item; and
present the at least one traceable test item during a computer-based testing session.

23. The system of claim 22, wherein the server facility is further configured to associate the unique identifier with the at least one test item based on a content of the at least one test item.

24. The system of claim 22, wherein the at least one test item comprises a plurality of words, and the server facility is further configured to alter the at least one test item in accordance with the unique identifier by replacing at least one particular word of the plurality of words with at least one replacement word comprising the unique identifier.

25. The system of claim 22, wherein the at least one test question comprises a plurality of numbers, and the server facility is further configured to alter the at least one test item in accordance with the unique identifier by replacing at least one particular number of the plurality of numbers with at least one replacement number comprising the unique identifier.

26. The system of claim 22, wherein the at least one test item comprises at least one image, and the server facility is further configured to alter the at least one test item in accordance with the unique identifier by replacing the at least one image with at least one traceable image comprising the unique identifier.

27. A system for facilitating computer-based testing, comprising a server facility configured to:
store at least one test item;
generate at least one traceable test item by altering the at least one test item in accordance with a unique identifier; and
present the at least one test item during a computer-based testing session.

28. The system of claim 27, wherein the at least one test item comprises a plurality of words, and the server facility is further configured to generate the at least one traceable test item by replacing at least one particular word of the plurality of words with at least one replacement word comprising the unique identifier.

29. The system of claim 27, wherein the at least one test question comprises a plurality of numbers, and the server facility is further configured to generate the at least one traceable test item by replacing at least one particular number of the plurality of numbers with at least one replacement number comprising the unique identifier.

30. The system of claim 27, wherein the at least one test item comprises at least one image, and the server facility is further configured to generate the at least one traceable test item by replacing the at least one image with at least one traceable image comprising the unique identifier.

31. A system for facilitating computer-based testing, comprising:
means for storing at least one test item;
means for associating a unique identifier with the at least one test item;
means for altering the at least one test item in accordance with the unique identifier to generate at least one traceable test item; and
means for presenting the at least one traceable test item during a computer-based testing session.

32. A system for facilitating computer-based testing, comprising:
means for storing at least one test item;
means for generating at least one traceable test item by altering the at least one test item in accordance with a unique identifier; and
means for presenting the at least one test item during a computer-based testing session.

33. A method for facilitating computer-based testing, comprising the steps of:
storing at least one test item;
associating a unique identifier with the at least one test item;
altering the at least one test item in accordance with the unique identifier to generate at least one traceable test item; and
presenting the at least one traceable test item during a computer-based testing session.

34. The method of claim 33, wherein the step of associating the unique identifier comprises the substep of associating the unique identifier with the at least one test item based on a content of the at least one test item.

35. The method of claim 33, wherein the at least one test item comprises a plurality of words, and the step of altering the at least one test item comprises the substep of replacing at least one particular word of the plurality of words with at least one replacement word comprising the unique identifier.

36. The method of claim 35, wherein the at least one replacement word comprises a synonym of the at least one particular word.

37. The method of claim 33, wherein the at least test item comprises a plurality of punctuation marks, and the step of altering the at least one test item comprises the substep of replacing at least one particular punctuation mark of the plurality of punctuation marks with at least one replacement punctuation mark comprising the unique identifier.

38. The method of claim 33, wherein the at least one test question comprises a plurality of numbers, and the step of altering the at least one test item comprises the substep of replacing at least one particular number of the plurality of numbers with at least one replacement number comprising the unique identifier.

39. The method of claim 33, wherein the at least one test item comprises at least one image, and the step of altering the at least one test item comprises the substep of replacing the at least one image with at least one traceable image comprising the unique identifier.

40. The method of claim 33, wherein the step of associating the unique identifier with the at least one test item comprises the substep of assigning the unique identifier to the at least one test item.

41. The method of claim 33, wherein the step of presenting the at least one test item during the Computer-Based Tests comprises the substep of manifesting the at least one test item during the computer-based test.

42. The method of claim 33, wherein the unique identifier comprises a unique test item delivery code.

43. A method for facilitating computer-based testing, comprising the steps of:
storing at least one test item;
generating at least one traceable test item by altering the at least one test item in accordance with a unique identifier; and
presenting the at least one test item during a computer-based testing session.

44. The method of claim 43, wherein the at least one test item comprises a plurality of words, and the step of generating the at least one traceable test item comprises the substep of replacing at least one particular word of the plurality of words with at least one replacement word comprising the unique identifier.

45. The method of claim 44, wherein the at least one replacement word comprises a synonym of the at least one particular word.

46. The method of claim 43, wherein the at least test item comprises a plurality of punctuation marks, and the step of generating the at least one test item comprises the substep of replacing at least one particular punctuation mark of the plurality of punctuation marks with at least one replacement punctuation mark comprising the unique identifier.

47. The method of claim 43, wherein the at least one test question comprises a plurality of numbers, and the step of generating the at least one traceable test item comprises the substep of replacing at least one particular number of the plurality of numbers with at least one replacement number comprising the unique identifier.

48. The method of claim 43, wherein the at least one test item comprises at least one image, and the step of generating the at least one traceable test item comprises the substep of replacing the at least one image with at least one traceable image comprising the unique identifier.

49. The method of claim 43, wherein the step of presenting the at least one test item during the Computer-Based Tests comprises the substep of manifesting the at least one test item during the computer-based test.

50. The method of claim 43, wherein the unique identifier comprises a unique test item delivery code.
